(19) United States
(12) Patent Application Publication
(10) Pub. No.: US 2011/0297094 A1
(43) Pub. Date: Dec. 8, 2011

(54) CALF FEEDING BOTTLE

(76) Inventor: Hans-Joachim Holm, Westerronfeld (DE)

(21) Appl. No.: 13/154,686

(22) Filed: Jun. 7, 2011

(30) Foreign Application Priority Data
Jun. 8, 2010 (DE) 20 2010 007 722.2

(51) Int. Cl. A01K 9/00

(52) U.S. Cl. 119/71

(57) ABSTRACT

A calf feeding bottle comprising a lower opening for connecting to a drinking teat, an upper opening for filling the feeding bottle and a lid for closing the upper opening, the lid being designed so that it may be pushed open by a filling device and is automatically closed again when the filling device is removed from the feeding bottle.

### FIELD OF THE INVENTION

The invention relates to a calf feeding bottle comprising a lower opening for connecting to a drinking teat, an upper opening for filling the feeding bottle and a lid for closing the upper opening as well as a calf feeding bottle comprising a drinking teat fastened to the feeding bottle at an angle.

### BACKGROUND OF THE INVENTION

Calves are fed with solid or liquid feed, in particular with milk. Both may be delivered via a drinking teat, on which the calf is able to draw and suckle. To this end, the use of buckets comprising a drinking teat arranged in a lower region is known. Said buckets generally remain open at the top, which is disadvantageous in terms of hygiene. Feeding bottles are also known which may be connected to a drinking teat. Feeding bottles are known which comprise a single opening, through which the feed, in particular the milk, is filled. After filling, a drinking teat is connected to the opening and the feeding bottle is fastened “on its head”, i.e. with the drinking teat at the bottom, to a calf stall so that the calf is able to reach the drinking teat easily. Feeding bottles comprising a lower opening for connecting to a drinking teat and an upper opening for filling are also known, said upper opening being closed by a lid after filling. The lids are screwed on manually or have a peripheral edge, which is also manually folded over an upper opening edge of the feeding bottle.

The feeding bottles are generally filled in a specific area comprising a filling station, where the feeding bottles are also cleaned if required. In large agricultural operations, several thousand feeding bottles have to be filled on a daily basis, which involves a considerable amount of manual work. The filled feeding bottles are then transported by a handcart or vehicle to the calf stalls and when the feeding is completed fetched from there again. A considerable amount of work is also required therefor.

### SUMMARY OF THE INVENTION

Proceeding therefrom, it is the object of the invention to provide a calf feeding bottle which permits feeding the calves with less work and which meets requirements in terms of hygiene.

This object is achieved by the calf feeding bottle having the features of claim 1. Advantageous embodiments are set forth in the subsequent sub-claims.

The calf feeding bottle according to the invention comprises a lower opening for connecting to a drinking teat, an upper opening for filling the feeding bottle and a lid for closing the upper opening, the lid being designed so that it may be pushed open by a filling device and automatically closes again when the filling device is removed from the feeding bottle.

The drinking teat is connected to the lower opening, in particular it may be placed, pushed, inserted or screwed onto a pipe connector formed in the region of the lower opening.

The upper filling opening may have a relatively large opening diameter, for example 50% of the largest diameter of the feeding bottle. The feeding bottle consists, for example, of a plastic material. It may have a volume of, for example, 2 to 5 litres. It may have an elongate shape and have a substantially circular or square/rectangular cross section. The lower opening may be arranged at the lowest point of the feeding bottle, the walls of the feeding bottle being able to extend obliquely relative to one another towards the lower opening.

The directional information “bottom”/“top”, “laterally” etc. always refers to a preferred position of use of the feeding bottle, in which a drinking teat connected to the lower opening is easily accessible from below and for a calf.

The lid serves for closing the upper opening, i.e. it protects the inside of the feeding bottle in the closed state from soiling by environmental effects such as rain, bird droppings, insects, etc. The closure may be completely or approximately sealed against the air and/or liquid, but this is not absolutely necessary.

The lid is configured so that it may be pushed open by a filling device. The filling device may be, in particular, a filling tube or a pump nozzle, via which the feed is filled into the feeding bottle from a storage container. So-called milk trolleys, i.e. manually-driven or motor-driven trolleys with a storage container for milk or the like are suitable, with a carrying capacity of, for example, 300 litres or more. Such milk trolleys may have a pump, with which the milk or other feed is delivered from the storage container via a pipeline or a tube to the filling device. By means of such a filling device, the lid may be pushed open, i.e. displaced into an open position, in particular by pushing or pressing with the filling device. The lid, therefore, does not have to be manually released from the upper opening edge in a separate operating step, in the manner of conventional lids. The lid may be opened solely by pushing open with the filling device, without it having to be touched by hand.

After removing the filling device from the feeding bottle, the lid automatically returns into a closed position again. It remains in this position until it is pushed open again.

The lid according to the invention is particularly easy to open and is automatically closed, so that the filling process is substantially simplified. The lid is specifically designed for supplying milk to the feeding bottle which remains on a calf stall. In this operating step, the transportation of the feeding bottles to and from a filling station is dispensed with.

The filling process is considerably simplified, as the lid does not have to be opened manually and closed again. In particular, it is possible to drive a milk trolley from calf stall to calf stall and to meter and/or fill the quantity of feed provided using the filling device into the feeding bottle, without having manual contact with the feeding bottle. In particular, it is possible at the same time to remain seated on a vehicle driven alongside which is used for distributing the feed. Thus the feeding process may be carried out almost “by driving past”. By the closure of the upper opening of the feeding bottle which is always ensured, this method is also particularly hygienic. If required, easy cleaning of the feeding bottle including the lid is also possible, whether by exchanging the feeding bottle and cleaning, for example, in a dishwasher or by rinsing the feeding bottle on the calf stall.

Relative to the known method of transporting filled feeding bottles to the calf stalls and fastening said feeding bottles thereto in a drinking position, a further simplification of the operation consists in not having to handle any heavy, filled feeding bottles. Only one compact filling device which is easy to handle has to be moved by hand.

In one embodiment, the lid bears in the closed state against one edge of the upper opening of the feeding bottle and/or protrudes laterally over one edge of the upper opening and/or laterally encloses one edge of the upper opening. By means of the aforementioned embodiments the upper edge of the feeding bottle is reliably covered and sealed and, in particular, protected from soiling from above. At the same time, easy opening of the lid is possible.

In one embodiment, the lid in the closed state has an actuating portion protruding from the feeding bottle, to be pushed open by the filling device, and which is arranged so that it is easily accessible for the filling device and may be moved in an opening direction of the lid. The actuating portion may be configured to be relatively large and have dimensions of, for example, 3 cm×8 cm or more, so that it may be easily actuated by the filling device.

In one embodiment, in the closed state of the feeding bottle the actuating portion protrudes obliquely outwards and upwards from a lateral edge of the lid. In this arrangement, the actuating portion may be moved by the filling device in a particularly simple manner upwards and towards a central axis of the feeding bottle in order to open up the upper opening.

In one embodiment, the actuating portion has a concave, curved actuating surface. Said actuating surface may cooperate with the filling device, the filling device being prevented from slipping off the actuating surface by the concave shape.

In one embodiment, the lid is articulated via a hinge with a pivot pin, the hinge predetermining the direction of a pivoting movement of the lid. As a result, the lid may be pushed open particularly easily by the filling device.

In one embodiment, a resilient element is present and the automatic closure takes place due to a force exerted by the resilient element on the lid. The resilient element may, for example, be a spring or a rubber band. Alternatively, instead of a resilient element, a cable control which is actuated by a weight by gravitational force, or by a counterweight connected rigidly to the lid, preferably on one side of the pivot pin of a hinge opposing the lid, may be impinged upon by a force into the closed position. The aforementioned possibilities are simple solutions which permit reliable automatic closure of the lid.

In one embodiment, the lid consists of a resilient deformable material and the automatic closure takes place due to the resilience of the material and/or the gravitational force of the lid. For example, the elastically deformable material may be rubber or another elastomer, in particular a sturdy rubber mat having a thickness of several millimetres or more. In the non-deformed state, the lid may have a shape adapted to the edge of the upper opening of the feeding bottle, so that after deformation it automatically returns to a closed position. This may be assisted by gravitational force. In the case of a rubber mat of relatively thick design, the two mechanisms cooperate advantageously, so that a particularly reliable and simple solution is achieved.

In one embodiment, the lid is connected to a fastening portion which may be fastened to one edge of the upper opening. The fastening portion may, for example, be annular and enclose the edge of the upper opening. By means of a screw connection it may be connected to the edge. A simple alternative is a snap connection. By means of the fastening portion, the lid may be fastened easily to the feeding bottle. Optionally, a simple replacement of the lid is also possible.

In one embodiment, the lid and the fastening portion are made in one piece from a resilient material. For example, the lid and the fastening portion may consist of a resilient material, so that the fastening portion, for example, may enclose the opening edge in an annular manner and be fixed thereto non-positively, the lid, for example, merging with the fastening portion in a portion which is a few centimetres long.

In one embodiment, the lid in the closed state bears against an inner face of one edge of the upper opening and opens into the feeding bottle. The lid may, for example, be designed as a flap pivoting into the feeding bottle. Said flap may be pressed downwards, in particular, from above by the filling device, in order to open up the opening and to be able to fill the feed into the feeding bottle.

In one embodiment, a bottle holder which may be fastened to a wall or to the bars of a calf stall is present, said bottle holder holding the bottle in a drinking position, in which a drinking teat connected to the lower opening may be easily reached by a calf. The bottle holder may receive a holding portion fastened to the feeding bottle or configured in one piece therewith, the holding portion being able to be inserted from above into the holder. Alternatively, the bottle holder may enclose the feeding bottle, so that the feeding bottle may be inserted into the holder, for example from above.

In one embodiment, the lid has one of the embodiments explained above but does not cooperate in the manner described above with an edge of the upper opening, but instead with an upper edge of the bottle holder. For example, the lid bears against an upper edge of the bottle holder, or a fastening portion of the lid may be fastened to an upper edge of the bottle holder. In this solution, the lid is associated with the bottle holder and the feeding bottle may, for example, be removed and cleaned separately from the lid.

In the conventional feeding bottles set forth in the introduction, the drinking teat longitudinal axis generally extends in the same direction as the feeding bottle longitudinal axis. In order to move the drinking teat into a position which may be easily reached by a calf, such feeding bottles are fastened in a position which is inclined relative to the vertical, for example by a receiver of a bottle holder oriented at a 45 degree angle to a wall or bars of the calf stall, into which the feeding bottle is inserted. In other conventional feeding bottles, the drinking teat longitudinal axis is inclined relative to a feeding bottle longitudinal axis, so that the feeding bottle may be fastened in an approximately vertical position. The drinking teat is thus located in an oblique position which may be easily reached by a calf. In both cases which have been outlined, however, the drinking teat protrudes laterally beyond the feeding bottle, so that it frequently results in the soiling of the drinking teat, in particular by falling bird droppings or the hindquarters of a calf, which may also soil the drinking teat with manure, straw or other dirt.

Proceeding therefrom, it is a further object of the invention to provide a calf feeding bottle comprising a drinking teat which permits feeding under improved hygienic conditions.

This object is achieved by the calf feeding bottle having the features of claim 14. Advantageous embodiments are set forth in the subsequent sub-claims.

The calf feeding bottle according to the invention comprises a bottle longitudinal axis and a drinking teat fastened to the feeding bottle, which has a teat longitudinal axis which is inclined at an angle of 30 degrees or more relative to the bottle longitudinal axis, the drinking teat being arranged so that it is located entirely below the feeding bottle when the bottle longitudinal axis is in a vertical arrangement.

By means of the aforementioned arrangement, the drinking teat is protected from soiling from above in a simple manner. Lateral contact with the drinking teat, namely by the hindquarters of a calf, is also avoided, as the calf is generally pushed away from contact with the drinking teat at a region of the feeding bottle protruding laterally beyond the drinking teat.

The invention is based on the recognition that maintaining the drinking teat itself clean is of particular importance, and soiling of the type explained above of the drinking teat may lead to the animal becoming ill. Remedial action is provided in a simple manner.

The bottle longitudinal axis is, in particular, the axis of symmetry of a substantially cylindrical or rotationally symmetrical bottle portion. The direction of the teat longitudinal axis is also defined by the substantially rotationally symmetrical and/or cylindrical shape of the sucking and/or suckling portion of the drinking teat. The teat longitudinal axis is inclined by 30 degrees or more, relative to the bottle longitudinal axis, for example even by 45 degrees or 60 degrees or more.

In one embodiment, the feeding bottle has a pipe connector to which the drinking teat is fastened, the pipe connector being arranged offset relative to the bottle longitudinal axis, and being located at the lowest point of the feeding bottle when the bottle longitudinal axis is vertically aligned. The drinking teat may be fastened to the pipe connector in the aforementioned manner, i.e. in particular by placing, pushing, inserting or screwing on. The arrangement of the pipe connector at the lowest point of the feeding bottle leads to a substantially complete emptying of the feeding bottle. This is also advantageous in terms of hygiene, in particular when the feeding bottle is not cleaned after each feed, but optionally is simply filled up again.

In one embodiment, the pipe connector is aligned according to the teat longitudinal axis. Then a conventional drinking teat may be used, and the desired arrangement of the drinking teat is predetermined solely by the arrangement and alignment of the pipe connector.

In one embodiment, a bottle holder which may be fastened to a wall or to the bars on a calf stall is present, said bottle holder holding the bottle in a drinking position, in which the bottle longitudinal axis is aligned approximately vertically. The aforementioned advantages are achieved with such a bottle holder.

In one embodiment, the bottle holder in a lower region has an elongate opening through which the drinking teat may be passed when inserting the bottle into the bottle holder in its inclined position relative to the bottle longitudinal axis. Accordingly, the feeding bottle may be easily inserted into the bottle holder after the drinking teat has already been fastened to the feeding bottle.

In one embodiment, the feeding bottle with the specific arrangement of the drinking teat has a lid according to one of the aforementioned features. As a result, the advantages of the specific lid are combined with those of the specific teat arrangement. This results in a particularly advantageous interaction, as the improved hygiene in the region of the drinking teat, in particular when refilling the feeding bottle, is significant.

### BRIEF DESCRIPTION OF THE DRAWINGS

The invention is explained hereinafter with reference to 4 figures, in which:

FIG. 1 shows a calf feeding bottle according to the invention comprising a lid in the closed state fastened to the upper edge of the feeding bottle,

FIG. 2 shows the feeding bottle of FIG. 1 with the lid open,

FIG. 3 shows a further exemplary embodiment of a calf feeding bottle comprising a lid in the closed state fastened to a bottle holder,

FIG. 4 shows the feeding bottle of FIG. 3 with the lid open.

All the figures show simplified cross-sectional views. In all the figures, the same reference numerals are used for corresponding parts.

### DETAILED DESCRIPTION OF THE INVENTION

FIG. 1 shows a feeding bottle 10 made of plastic material. The feeding bottle 10 has a substantially square cross section with well-rounded corners. A lower opening 12 of the feeding bottle 10 is connected to a drinking teat 14. The drinking teat 14 consists of rubber and is pushed onto a pipe connector 16 of the feeding bottle, which has the lower opening 12. The pipe connector 16 is located at the lowest point of the feeding bottle 10, so that complete emptying of the feeding bottle 10 is possible through the drinking teat 14. The drinking teat 14 has a teat longitudinal axis 18 which is inclined relative to the bottle longitudinal axis 20 at an angle of approximately 45 degrees.

As is clearly visible in FIG. 1, the drinking teat 14 is arranged completely underneath the feeding bottle 10. Soiling of the drinking teat from above is thus excluded. Also, soiling by contact with the drinking teat 14 from the side is substantially avoided.

The feeding bottle 10 has an upper opening 22 for filling the feeding bottle. In the view of FIG. 1, the upper opening 22 is closed by a lid 24, which bears on an edge of the upper opening 22. The lid 24 consists of a rubber mat, approximately 5 millimetres thick, an actuating portion 26 being arranged on the edge thereof facing an operator. The actuating portion 26 protrudes obliquely outwards and upwards so that it may be actuated easily by a filling device 28 in the form of a pump nozzle for opening the lid 24.

The lid 24 is connected in one piece to a fastening portion 30, also consisting of rubber, which encloses the edge of the upper opening 22.

FIG. 1 further shows a bottle holder 32 which also consists of a plastic material. The bottle holder 32 has at the bottom an opening 34 through which the pipe connector 16 and the drinking teat 14 protrude from the bottle holder 32. The drinking teat 14 is thus easily accessible for a calf. The bottle holder 32 encloses the feeding bottle 10 over a large part of its length from all sides, so that the feeding bottle 10 is held securely in the bottle holder 32. The feeding bottle 10 may be easily pulled out of the bottle holder 32 upwards and also easily inserted again into the bottle holder 32 from the top.

The upper opening 22 has a large diameter which makes up approximately 85% of the diameter of the feeding bottle 10.

The bottle holder 32 is screwed to a plate-shaped connecting piece 36, which is fastened to bars, not shown, or a wall of a calf stall or is part thereof

In FIG. 1 is shown how the filling device 28 comes to bear against the fastening portion 26 of the lid 24. The lid 24 is pushed open by further movement of the filling device 28 toward the bottle longitudinal axis 20 and/or obliquely upwards. To this end, the lid 24 does not have to be touched by hand.

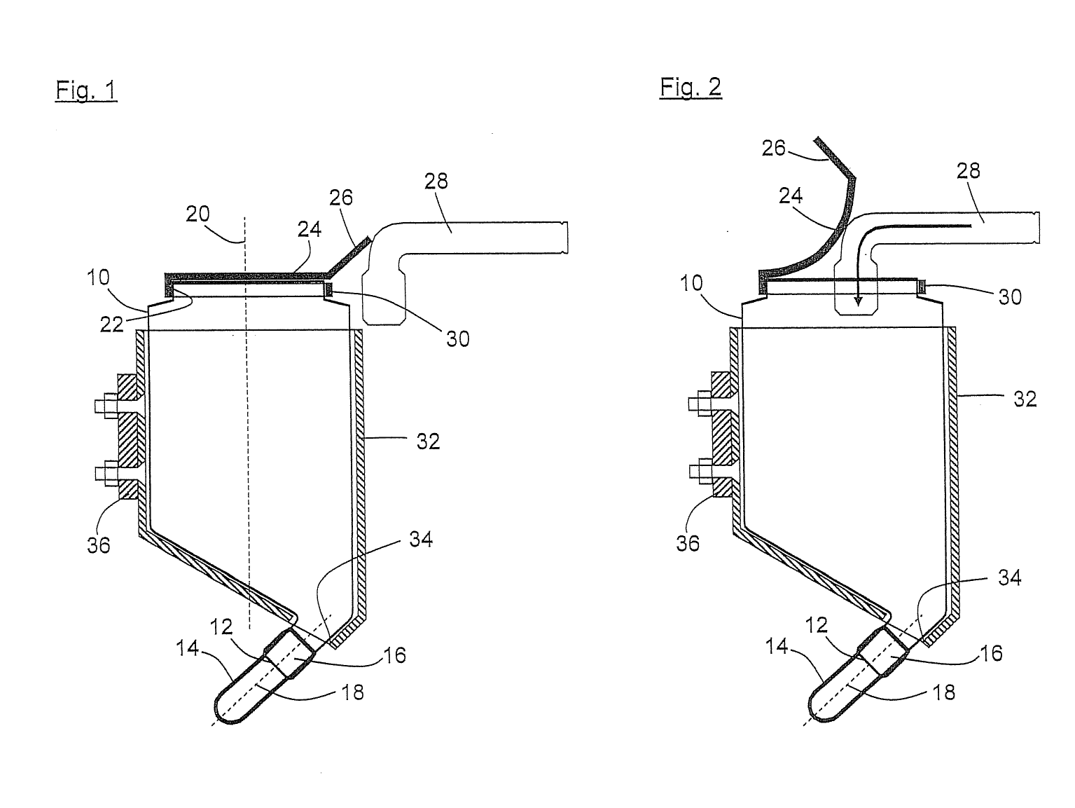

In the view of FIG. 2, the lid 24 has been opened sufficiently far for the filling device to be able to be arranged above the upper opening 22 and/or protruding therein. In this position, the feeding bottle 10 may be easily filled via the filling device 28, in particular by an automatic metering device. The lid 24 is curved in this position. After removing the filling device 28 from the feeding bottle, the lid 24 is automatically closed by a resilient return deformation of the lid 24 and additionally assisted by the gravitational force acting on the lid 24.

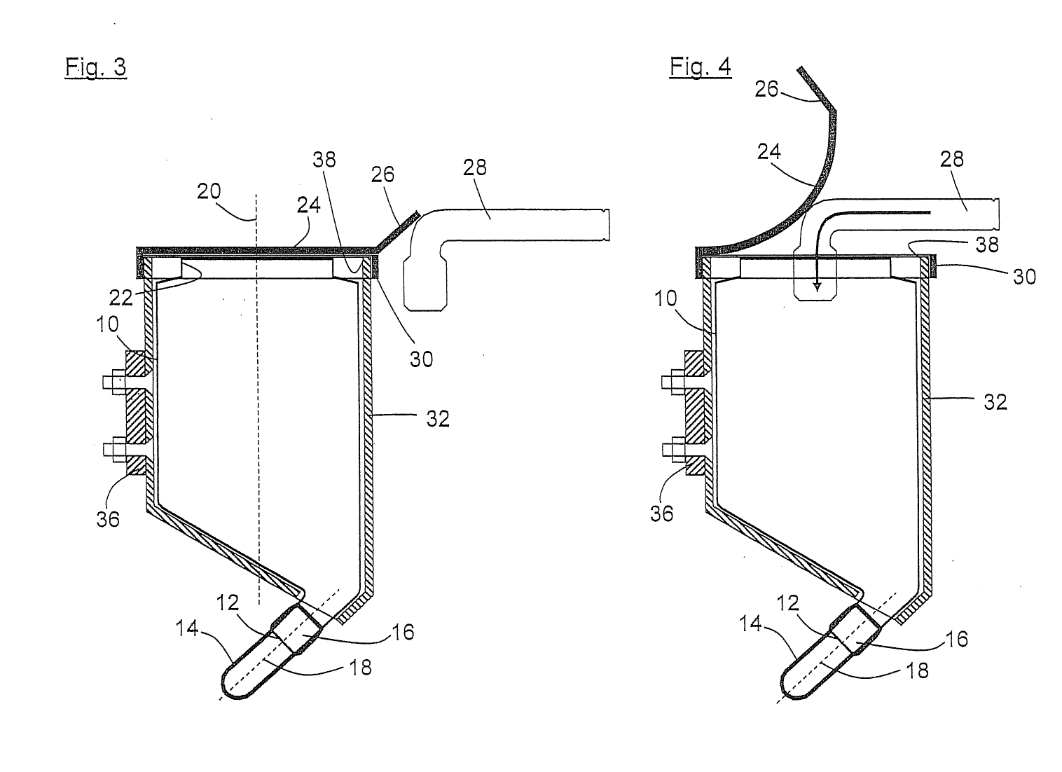

The exemplary embodiment of FIGS. 3 and 4 differs from that of FIGS. 1 and 2, in that the bottle holder 32 extends over the entire length of the feeding bottle 10 and, in particular, terminates approximately flush with the edge of the upper opening 22. A fastening portion of the lid 24 encloses an upper edge portion 38 of the bottle holder 32 from the outside. It is configured in one piece with the lid 24. Also in this embodiment, the upper opening 22 is reliably and automatically closed by the lid 24. FIG. 4 shows an open position of the lid 24, the embodiments being similar to the first exemplary embodiment of FIGS. 1 and 2.

What is claimed is:

1. A calf feeding bottle comprising a lower opening (12) for connecting to a drinking teat (14), an upper opening for filling the feeding bottle and a lid (24) for closing the upper opening (22), the lid (24) being designed so that it may be pushed open by a filling device (28) and is automatically closed again when the filling device (28) is removed from the feeding bottle.

2. The feeding bottle according to claim 1, wherein the lid (24) in the closed state bears against one edge of the upper opening (22) of the feeding bottle or protrudes laterally over one edge of the upper opening (22) and laterally encloses one edge of the upper opening (22).

3. The feeding bottle according to claim 1, wherein the lid (24) in the closed state has an actuating portion (26) protruding from the feeding bottle, to be pushed open by the filling device (28), and which is arranged so that it is easily accessible for the filling device (28) and may be moved in an opening direction of the lid (24).

4. The feeding bottle according to claim 3, wherein the actuating portion (26) protrudes obliquely outwards and upwards from a lateral edge of the lid (24) in the closed state.

5. The feeding bottle according to claim 3, wherein the actuating portion (26) has a concave, curved actuating surface.

6. The feeding bottle according to claim 1, wherein the lid (24) is articulated via a hinge with a pivot pin, said hinge predetermining the direction of a pivoting movement of the lid (24).

7. The feeding bottle according to claim 1, further comprising a resilient element and the automatic closure takes place due to a force exerted by the resilient element on the lid (24).

8. The feeding bottle according to claim 1, wherein the lid (24) consists of a resilient deformable material and the automatic closure takes place due to the resilience of the material or the gravitational force of the lid (24).

9. The feeding bottle according to claim 1, wherein the lid (24) is connected to a fastening portion (30) which may be fastened to one edge of the upper opening (22).

10. The feeding bottle according to claim 9, wherein the lid (24) and the fastening portion (30) are made in one piece from a resilient material.

11. The feeding bottle according to claim 1, wherein the lid (24) in the closed state bears against an inner face of one edge of the upper opening (22) and opens into the feeding bottle.

12. The feeding bottle according to claim 1, further comprising a bottle holder (32) which may be fastened to a wall or to the bars of a calf stall, said bottle holder holding the feeding bottle in a drinking position, in which a drinking teat (14) connected to the lower opening (12) may be easily reached by a calf

13. The feeding bottle according to claim 12, wherein the lid (24) in the closed state bears against one edge of the upper opening (22) of the feeding bottle or protrudes laterally over one edge of the upper opening (22) and laterally encloses one edge of the upper opening (22), an upper edge (38) of the bottle holder (32) approaching the location of the edge of the upper opening (22) of the feeding bottle.

14. A calf feeding bottle comprising a bottle longitudinal axis (20) and a drinking teat (14) fastened to the feeding bottle, which has a teat longitudinal axis (18) which is inclined at an angle of 30 degrees or more relative to the bottle longitudinal axis (20), the drinking teat (14) being arranged so that it is located entirely below the feeding bottle when the bottle longitudinal axis (20) is in a vertical arrangement.

15. The feeding bottle according to claim 14, wherein the feeding bottle has a pipe connector (16) to which the drinking teat (14) is fastened, the pipe connector (16) being arranged offset relative to the bottle longitudinal axis (20), and being located at the lowest point of the feeding bottle when the bottle longitudinal axis (20) is vertically aligned.

16. The feeding bottle according to claim 14, wherein the pipe connector (16) is aligned according to the teat longitudinal axis (18).

17. The feeding bottle according to claim 14, further comprising a bottle holder (32) which may be fastened to a wall or to the bars of a calf stall, said bottle holder holding the feeding bottle in a drinking position, in which the bottle longitudinal axis (20) is aligned approximately vertically.

18. The feeding bottle according to claim 17, wherein the bottle holder (32) in a lower region has an elongate opening through which the drinking teat (14) may be passed when inserting the bottle into the bottle holder (32) in its inclined position relative to the bottle longitudinal axis (20).

19. The feeding bottle according to claim 14, wherein the feeding bottle has a lid (24) designed so that it may be pushed open by a filling device (28) and is automatically closed again when the filling device (28) is removed from the feeding bottle.
